(19) United States
(12) Patent Application Publication
(10) Pub. No.: US 2010/0206542 A1
(43) Pub. Date: Aug. 19, 2010

(54) COMBINED MULTI-STREAM HEAT EXCHANGER AND CONDITIONER/CONTROL UNIT

(76) Inventors: Andrew Francis Johnke, Beresford, SD (US); W. Larry Lewis, Houston, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/372,604

(22) Filed: Feb. 17, 2009

(51) Int. Cl. G05D 23/00; F28F 1/10; F28D 7/00; F25B 29/00

(52) U.S. Cl. 165/279; 165/181; 165/140; 165/58

(57) ABSTRACT

Methods and apparatus for heating and cooling portions of a fluid are provided. The method may include flowing a stream of a fluid through a first coil of a heat exchanger, separating a liquid component from the stream of the fluid, flowing the liquid component through a second coil of the heat exchanger, and flowing the stream of the fluid leaving the first coil over the first coil and the second coil, thereby cooling the stream of fluid flowing through the first coil and heating the liquid component flowing through the second coil. The apparatus may include a housing, a heat exchanger disposed within the housing, a separation chamber disposed within the housing and operable to separate a liquid component of the fluid, and a control system in fluid communication with the separation chamber and the heat exchanger, wherein the control system is operable to direct the liquid component from the separation chamber to the heat exchanger.

### BACKGROUND OF THE INVENTION

1. Field of the Invention

Embodiments of the invention relate to methods and apparatus for treating a fluid, and in particular to heating and cooling portions of the fluid. Embodiments of the invention also relate to a fuel gas conditioning unit. Embodiments of the invention also relate to a dew point control unit. In addition, embodiments of the invention relate to a combination of a multi-stream heat exchanger and a fuel gas conditioning unit or a dew point control unit.

2. Description of the Related Art

Modern lean burn gas fueled engines are sensitive to the gas heating value. High BTU gas can quickly damage major engine components and dramatically increase maintenance cost. A fuel gas conditioning unit is typically used to separate and remove the propane and heavy hydrocarbons from a high BTU gas stream to provide a lean lower BTU fuel stream. In one example, the conditioned fuel stream may be supplied to a natural gas engine that is driving a compressor at a recompression station along a pipeline. Typically, the pressure drop of the fuel gas from the pipeline pressure to the engine supply may provide the necessary refrigeration of the fuel gas so that no moving parts are required.

Produced gas near the hydrocarbon dew point must also often be conditioned to lower the content of the high molecular weight components of the gas to meet certain dew point requirements, prior to introduction into a pipeline or transfer to an end-user consumer. A hydrocarbon dew point control unit separates and removes the propane and heavy hydrocarbons and provides lower BTU outlet gas to the pipeline or other outlet source. Either the pressure drop of the inlet gas from pipeline pressure provides the necessary refrigeration so that no moving parts are typically required, or an external refrigeration system can be used to provide the refrigeration. Residue recompression is typically required to send the conditioned gas to the pipeline. As an alternative, an external refrigeration system can be supplied so that pressure drop through the system is minimized and no recompression is required.

In any fuel gas conditioning or dew point control unit, the inlet gas must be dehydrated or a hydrate suppressant must be added to prevent water freeze-up. Methanol or ethylene glycol or molecular sieve dehydration or regenerative glycol units can be used to remove the water. The type of system, the BTU reduction required, and the minimum operating temperature are key elements in deciding the type of water/hydrate control.

There is a continuous need for more cost effective, efficient, and compact conditioning and control units as described above.

### SUMMARY OF THE INVENTION

Embodiments of the invention relate to methods and apparatus for treating a fluid, and in particular to heating and cooling portions of the fluid. Embodiments of the invention relate to a fuel gas conditioning unit. Embodiments of the invention relate to a dew point control unit. Embodiments of the invention relate to a combination of a multi-stream heat exchanger and a fuel gas conditioning unit or a dew point control unit.

In one embodiment, an apparatus for treating a fluid comprises a housing, a heat exchanger disposed within the housing, a separation chamber disposed within the housing and operable to separate a liquid component of the fluid, and a control system in fluid communication with the separation chamber and the heat exchanger. The control system is operable to direct the liquid component from the separation chamber to the heat exchanger.

In one embodiment, a heat transfer apparatus comprises a body, a first series of coils having a plurality of tubes, and a second series of coils having one or more tubes intertwined with the plurality of tubes of the first series of coils.

In one embodiment, a method of heating and cooling a fluid in a heat exchanger comprises flowing a first stream of a fluid through a first series of coils of the heat exchanger, flowing a second stream of the fluid through a second series of coils of the heat exchanger, and flowing a third stream of the fluid over the first and second series of coils such that the third stream cools the first stream and heats the second stream.

In one embodiment, a method of treating a fluid comprises flowing a stream of a fluid through a first coil of a heat exchanger, separating a liquid component from the stream of fluid, flowing the liquid component through a second coil of the heat exchanger, and flowing the stream of the fluid leaving the first coil over the first coil and the second coil, thereby cooling the stream of fluid flowing through the first coil and heating the liquid component flowing through the second coil.

In one embodiment, a method of treating a fluid comprises flowing a stream of a fluid through a first coil of a heat exchanger, flowing a refrigerant stream through a second coil of the heat exchanger, separating a liquid component from the stream of the fluid flowing through the first coil, flowing the liquid component through a third coil of the heat exchanger, and flowing the stream of the fluid over the first coil, the second coil, and the third coil, thereby cooling the stream of the fluid flowing through the first coil, heating the refrigerant stream flowing through the second coil, and heating the liquid component flowing through the third coil.

In one embodiment, a method of reducing a heating value of a natural gas stream comprises flowing the natural gas stream through a first coil of a heat exchanger, cooling the natural gas stream, thereby separating a liquid portion of the natural gas stream having a greater heat value than the rest of the cooled natural gas stream, flowing the liquid portion through a second coil of the heat exchanger, flowing the cooled natural gas stream over the first and second coils, heating the cooled natural gas stream flowing over the first and second coils using the natural gas stream flowing through the first coil, and heating the liquid portion flowing through the second coil using the heated natural gas stream flowing over the first and second coils.

In one embodiment, method of controlling the hydrocarbon dew point of a natural gas stream comprises flowing the natural gas stream through a first coil of a heat exchanger, separating a component of the natural gas stream having a dew point greater than the rest of the natural gas stream, flowing the component through a second coil of the heat exchanger, flowing the cooled natural gas stream over the first and second coils, heating the cooled natural gas stream flowing over the first and second coils using the natural gas stream flowing through the first coil, and heating the component flowing through the second coil using the heated natural gas stream flowing over the first and second coils.

In one embodiment, an apparatus for treating a fluid stream comprises a housing, a heat exchanger disposed within the housing and operable to cool the fluid stream, and a control system coupled to the housing and the heat exchanger. The control system is operable to direct a portion of the cooled fluid stream from the housing to the heat exchanger and the heat exchanger is operable to heat the portion of the cooled fluid stream.

In one embodiment, a method of treating a fluid comprises flowing the fluid through a first coil of a heat exchanger, flowing a refrigerant stream through a refrigeration coil of a refrigeration system, flowing the fluid across the refrigeration coil, thereby separating the fluid into a gas component and a liquid component, flowing the liquid component through a second coil of the heat exchanger, and flowing the gas component over the first coil and the second coil, thereby cooling the stream of the fluid flowing through the first coil and heating the liquid component flowing through the second coil.

In one embodiment, an apparatus for treating a fluid stream comprises a housing, a heat exchanger disposed within the housing and operable to condition the fluid stream, a refrigeration system disposed within the housing in fluid communication with the heat exchanger such that the refrigeration system is operable to separate the fluid stream into a gas component and a liquid component, and a control system coupled to the housing and the heat exchanger such that the control system is operable to direct the liquid component to the heat exchanger.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a process and instrumentation diagram according to one embodiment of the invention.

FIG. 2 is a perspective view of a system according to one embodiment of the invention.

FIG. 3 is a perspective view of one end of the system according to one embodiment of the invention.

FIG. 4 is another perspective view of one end of the system according to one embodiment of the invention.

FIG. 5 is a perspective view of the heat exchanger located within the system according to one embodiment of the invention.

FIG. 6 is another perspective view of the system according to one embodiment of the invention.

FIG. 7 is a top view of the system according to one embodiment of the invention.

FIG. 8 is a side view of the system according to one embodiment of the invention.

FIG. 9 is another side view of the system according to one embodiment of the invention.

FIG. 10 is a side view of the heat exchanger according to one embodiment of the invention.

FIG. 11 is a bottom view of the heat exchanger according to one embodiment of the invention.

FIG. 12 is another side view of the heat exchanger according to one embodiment of the invention.

FIG. 13 is a perspective view of the heat exchanger according to one embodiment of the invention.

FIG. 14 is another perspective view of the heat exchanger according to one embodiment of the invention.

FIG. 15 is another perspective view of an upper portion of the heat exchanger according to one embodiment of the invention.

FIG. 16 is a side view of a first coil and a second coil according to one embodiment of the invention.

FIG. 17 is a process and instrumentation diagram of a system according to one embodiment of the invention.

FIGS. 18-20 are isometric views of the system according to embodiments of the invention.

FIGS. 21-24 are sectional views of the system according to embodiments of the invention.

### DETAILED DESCRIPTION

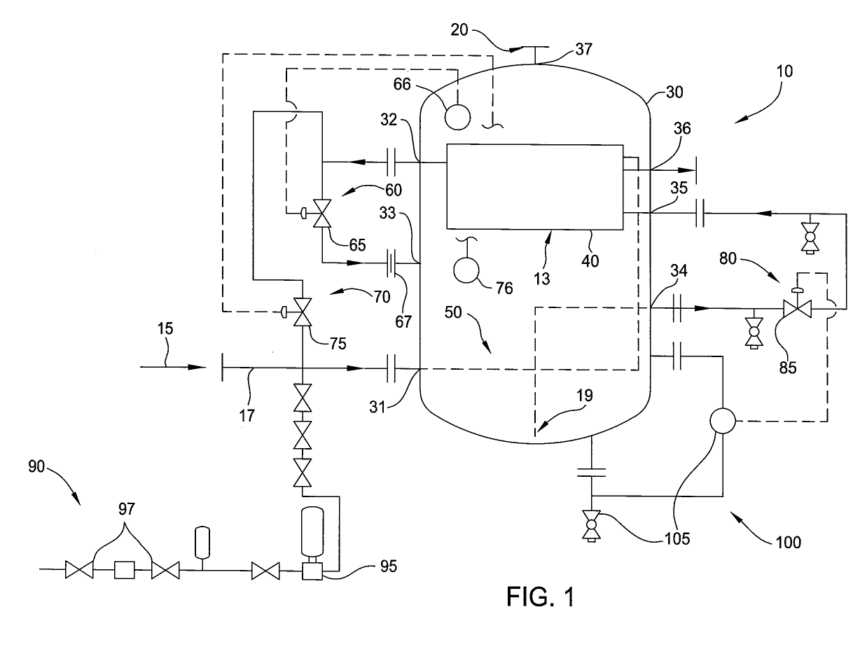

FIG. 1 illustrates a process and instrumentation diagram of a system 10. The system 10 is operable to treat a variety of fluids, such as hydrocarbon bearing fluids. In one embodiment, the system 10 may be a fuel gas conditioning unit operable to reduce the heating value of a gas stream, by separating and removing propane and heavy hydrocarbons from the gas stream to provide a lean lower BTU fuel stream. In one embodiment, the system 10 may be a dew point control unit operable to control the hydrocarbon dew point of a gas stream by lowering the hydrocarbon dew point of the gas stream to prevent liquid formation in the gas stream or by increasing the hydrocarbon dew point of a separated portion of the gas stream to stabilize the separated portion of the gas stream, for transfer to a pipeline or other end-user consumer of gas.

In one embodiment, the system 10 is used to treat a natural gas stream 15 to produce a conditioned fuel gas stream 20. The conditioned fuel gas stream 20 may have a constant BTU/hr. content, a lower BTU value, and/or a lower hydrocarbon dew point than the natural gas stream 15. This conditioning is beneficial for gas turbines and for reciprocating engines, as well as for meeting hydrocarbon dew point requirements and preventing liquid formation in the conditioned gas stream.

The system 10 has a housing 30, a heat exchanger 40 located in the housing, a separation chamber 50 located in the housing, a pressure control system 60, a temperature control system 70, a liquid control system 80, and an optional injection system 90. The housing may include a metallic (such as aluminum, carbon steel, or stainless steel) cylindrical vessel surrounding the heat exchanger 40. Exemplary heat exchangers 40 include a fin and tube type heat exchanger, a plate fin and tube type heat exchanger, or a brazed aluminum type heat exchanger. One advantage of a fin and tube heat exchanger is that the surface area ratio between the tube side and the fin side facilitates heat transfer. For example, a fin and tube heat exchanger may compensate for differences in the heat transfer coefficients of the fluids flowing through the tube side and the fluids flowing around the tubes on the fin side. The components of the heat exchanger 40 may be formed from a metallic material, such as aluminum. As will be described herein, multiple heat exchange streams (hot and cold) are introduced into the heat exchanger 40. The advantages of having multiple heat exchange streams in a single heat exchanger include a compact design, less weight and footprint, easy maintenance, and cost savings. The system 10 may be used in applications where space, weight, and footprint are important, such as off-shore oil platforms.

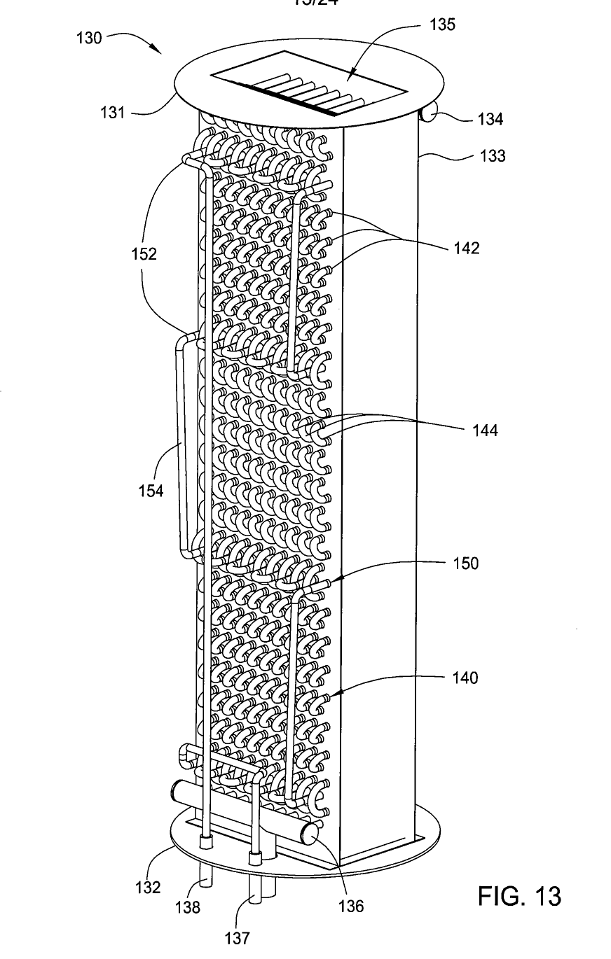

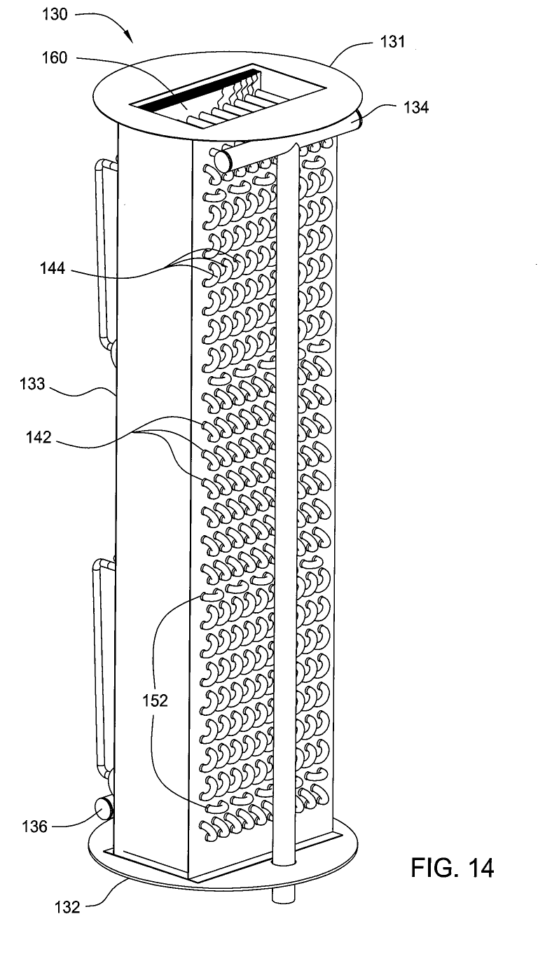

As illustrated in FIG. 1, and according to one embodiment, a high pressure (about 600 PSIG to about 900 PSIG) natural gas stream 15 enters an inlet 31 of the housing 30 at about ambient temperature. The high pressure natural gas stream 15 may be injected into the housing 30 using an injection quill 17. The high pressure natural gas stream 15 is directed to a first series of coils (shown in FIG. 14) and enters a tube side of the heat exchanger 40. The high pressure natural gas stream 15 is cooled to about 30 degrees Fahrenheit as it passes through the heat exchanger 40. The high pressure natural gas stream 15 is cooled as it flows through the first series of coils by a low pressure natural gas stream 13 (described below) that is directed across the fin side of the first series of coils of the heat exchanger 40. The high pressure gas stream 15 is also cooled as it flows through the first series of coils by a natural gas condensate 19 (described below) flowing through a second series of coils (shown in FIG. 13) of the heat exchanger 40. In one embodiment, portions of the flow of the fluids in the first and second series may be directed concurrent, countercurrent, and/or perpendicular to each other. In one embodiment, the fluid flowing across the fin side of the heat exchanger 40 may be directed substantially perpendicular to the flow of fluids in the first and second series of coils of the heat exchanger 40.

The high pressure natural gas stream 15 exits the first series of coils where it is then directed through an exit 32 of the housing 30 to a pressure control system 60 located adjacent the housing 30. The high pressure natural gas stream 15 is then reduced and expanded through one or more devices 65, such as a pressure regulator or a pressure control valve, such as a J-T valve, and/or one or more devices 67, such as a restrictive orifice, of the pressure control system 60 to a lower pressure range of about 50 PSIG to about 200 PSIG. The pressure control system 60 is operable to maintain and control the pressure within the housing 30. In one embodiment, the pressure control system 60 may include one or more sensors 66 adapted to monitor the pressures of the multiple streams as they are directed through the system 10. Expansion of the natural gas stream 15 may also cool the stream to about −20 degrees Fahrenheit by the Joule-Thompson effect. The pressure and temperature changes experienced by the high pressure natural gas stream 15 induce the stream to undergo certain phase changes. The high pressure natural gas stream 15 may drop below the hydrocarbon dew point of some of the components of the stream 15. The temperature and pressure drops convert the high pressure gas stream 15 into a low pressure two-phase stream having a gas component 13 and a liquid component 19, such as natural gas condensate.

The two-phase natural gas stream then enters an inlet 33 of the housing 30 to the separation chamber 50 where it may experience further phase-composition changes. Inside the housing, the two phase gas stream is separated into the natural gas condensate 19 and the low pressure natural gas stream 13. The natural gas condensate 19 accumulates in the separation chamber 50 at the bottom of the housing 30, which is in fluid communication with the liquid control system 80. In one embodiment, the separation chamber 50 may be the lower end of the housing 30 adjacent the heat exchanger 40. The low pressure gas stream 13 is directed across the fin side of the first and second series of coils of the heat exchanger 40 and is heated to ambient temperature. The treated low pressure gas stream 13 in the heat exchanger 40 may be referred to as the conditioned fuel gas stream 20. The low pressure natural gas stream 13 directed across the fin side of heat exchanger 40 is heated by the high pressure natural gas stream 15 that is flowing through the first series of coils. The low pressure natural gas stream 13 directed across the fin side of heat exchanger 40 may also be cooled by the natural gas condensate 19 (described below) that is flowing through the second series of coils of the heat exchanger. Therefore, the low pressure natural gas stream 13 flowing across the fin side of the heat exchanger 40 may act as both a cold stream and a hot stream depending on its heat transfer with the fluids flowing through the first and second series of coils of the heat exchanger 40. The conditioned fuel gas stream 20 is directed to an exit 37 of the housing and may be used as a fuel gas. In one embodiment, the pressure within the housing 30 may be used to direct the low pressure gas natural gas stream 13/conditioned fuel gas stream 20 across the heat exchanger 40 and out of the housing 30.

The natural gas condensate 19, which is at about −20 degrees Fahrenheit, is collected within the separation chamber 50 and is directed through an exit 34 of the housing 30 to the liquid control system 80 located adjacent the housing 30. The natural gas condensate 19 is then re-directed to an inlet 35 of the housing 30 into the second series of coils and enters the tube side of the heat exchanger 40 via one or more devices 85, such as a siphon, pump, and/or a valve, of the liquid control system 80. The natural gas condensate 19 may be used to provide additional refrigeration for efficiency and flexibility of the system 10. The natural gas condensate 19 is then heated from about −20 degrees Fahrenheit to ambient temperature and exits the tube side of the heat exchanger 40 to an exit 36 of the housing 30. The natural gas condensate 19 directed through the second series of coils of the heat exchanger 40 is heated by the high pressure natural gas stream 15 flowing through first series of coils of the exchanger 40. The natural gas condensate 19 is also heated by the low pressure natural gas stream 13 flowing across the fin side of heat exchanger 40. The heated natural gas condensate 19 may then be used for other applications. In one embodiment, the pressure within the housing 30 may be used to direct the natural gas condensate 19 through the liquid control system 80, the heat exchanger 40, and out of the housing 30.

In one embodiment, the temperature control system 70 may be in fluid communication with the high pressure natural gas stream 15, the housing 30, the pressure control system 60, the liquid control system 80, and/or the injection system 90 to help maintain and control the temperature of the fluids in the system 10. The temperature control system 70 may include one or more devices 75, such as a temperature control valve. In one embodiment, the temperature control system 70 may include one or more sensors 76 adapted to monitor the temperature of the high pressure and low pressure natural gas streams 15 and 13 as they are directed through the system 10. In one embodiment, the temperature control system 70 may include a monitoring system operable to heat the natural gas streams 15 and 13 as they are directed through the system 10 upon sensing a specified temperature. For example, the lower pressure natural gas stream 13 may be heated by introducing a portion of the high pressure natural gas stream 15 into the natural gas stream 13. In another example, the temperature control system 70 may be operable to inject a portion of the natural gas stream 15, prior to its entrance into inlet 31 of the housing 30, into a portion of the natural gas stream 15 exiting from the exit 32 of the housing 30 to heat the natural gas stream 15 before its entrance into the pressure control system 60. The temperature control system 70 may be operable to inject the portion of the natural gas stream 15 upon sensing a temperature above or below a specified temperature. In one embodiment, the temperature control system 70 is operable to maintain the temperature of the fluids in the system 10 within a specified temperature range using the embodiments discussed herein.

In one embodiment, the injection system 90 may be in fluid communication with the natural gas stream 15, the housing 30, the pressure control system 60, the temperature control system 70, and/or the liquid control system 80. The injection system 90 may be used to dehydrate the fluids in the system 10, such as with the addition of a hydrate suppressant to the fluids to prevent water freeze-up. Exemplary injection systems include a methanol or ethylene glycol injection system 90 may be used. Other suitable injection systems include a molecular sieve dehydration or regenerative glycol injection system 90 may be utilized. In one embodiment, the injection system 90 may include one or more devices 95, such as a pump and flow monitoring devices, and/or one or more devices 97, such as a series of valves or flow control devices.

In one embodiment, a fluid may be injected into the system 10 and the heat exchanger 40 at a temperature of about 120 degrees Fahrenheit. The fluid may be cooled to a temperature of about 45 degrees Fahrenheit as it exits the heat exchanger 40 and enters the pressure control system 60. The fluid may be cooled to about −4 degrees Fahrenheit as it exits the pressure control system 60 and enters the separation chamber 50. The fluid may be separated into a first portion and a second portion as is passes through the separation chamber 50. The first portion may be directed across the heat exchanger at a temperature of about −4 degrees Fahrenheit and heated to a temperature of about 110 degrees Fahrenheit as it flows out of the system 10. The second portion of the fluid may be directed through the liquid control system 80 at a temperature of about −5 degrees Fahrenheit. The second portion of the fluid may then be directed through the heat exchanger 40 and heated to a temperature of about 95 degrees Fahrenheit as it flows out of the system 10.

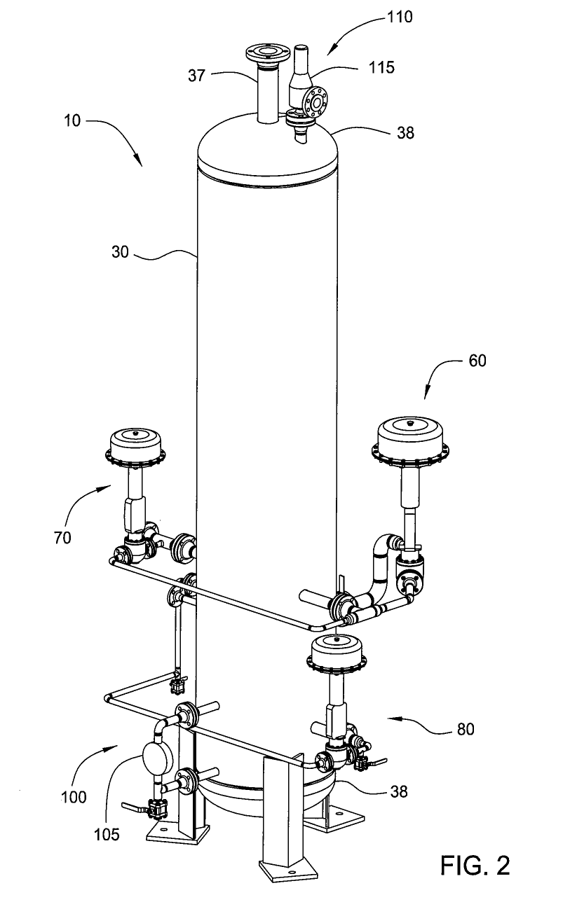

FIG. 2 illustrates a perspective view of the system 10, according to one embodiment. FIG. 2 illustrates a vertically disposed metallic cylindrical housing 30 with spherically shaped ends 38. The pressure, temperature, and liquid control systems 60, 70, and 80, respectively, are located at a lower end of the housing 30. A level control system 100 is also shown in fluid communication with the housing 30. The level control system 100 may include one or more devices 105, such as a drain valve and a level monitoring device. The level control system 100 may be operable to maintain a specified level of liquids within the housing 30. A safety control system 110 may also be located at an upper end of the housing 30. The safety control system may include one or more devices 115, such as a safety control valve. The safety control system 110 may be operable to prevent the pressure within the housing 30 from rising above a specified pressure.

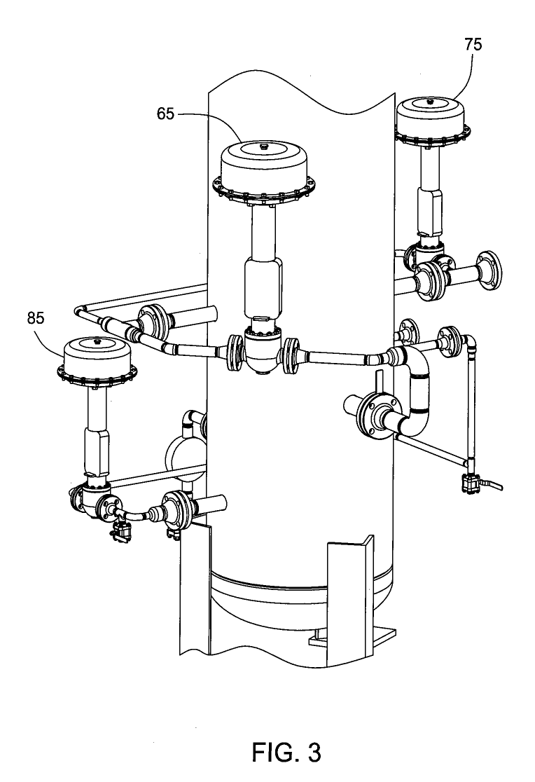

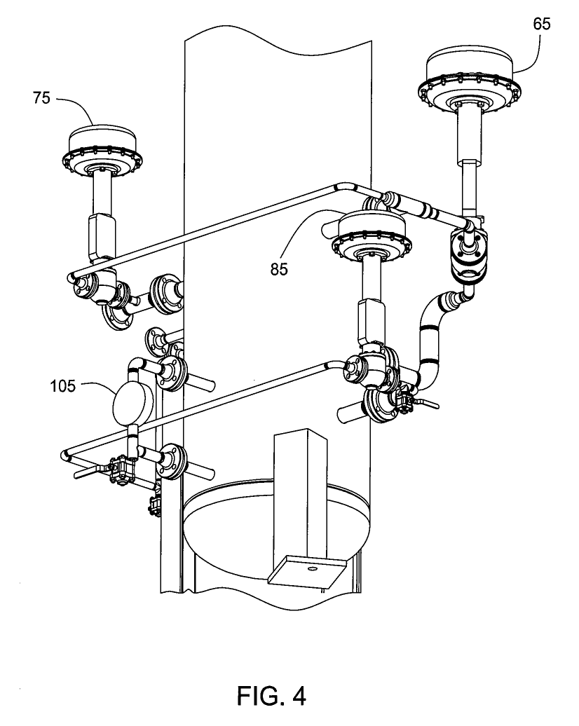

FIGS. 3 and 4 illustrate alternate perspective views of the lower end of the system 10. FIGS. 3 and 4 illustrate the one or more devices 65, 75, 85, and 105 of the control systems identified above.

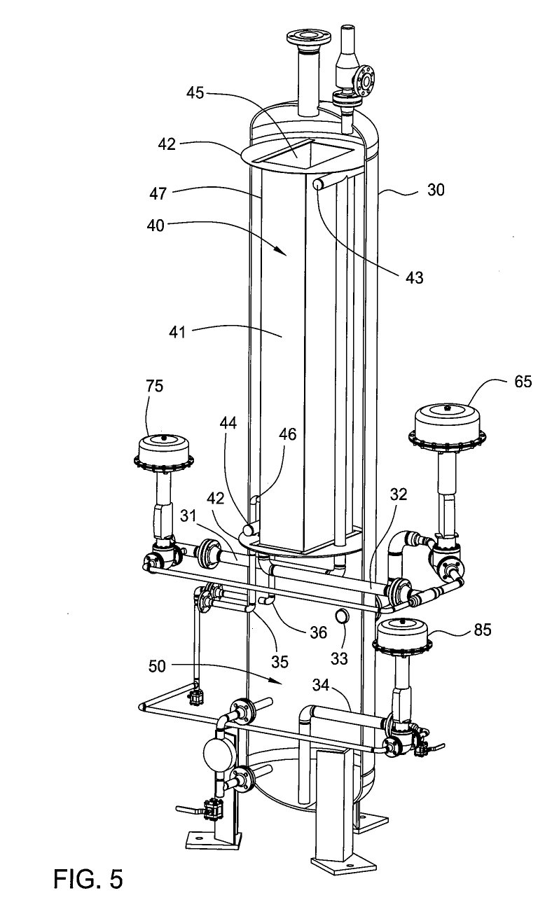

FIG. 5 illustrates the heat exchanger 40 vertically disposed within the housing 30. The heat exchanger 40 includes a metallic rectangular-shaped body 41 having circular-shaped ends 42. The ends 42 of the body 41 are in sealing engagement with the inner surface of the housing 30. The heat exchanger 40 includes a flow path 45 disposed through the body 41 along the longitudinal length of the body 41. The flow path 45 is the path along which the low pressure natural gas stream 13 is directed across the fin side of the heat exchanger 45. The low pressure natural gas stream 13 enters and flows from the lower end of the heat exchanger 45 to the upper end of the heat exchanger 40 substantially perpendicular to the first and second series of coils.

The heat exchanger 40 includes an inlet manifold 43 and an exit manifold 44 that are in fluid communication with the first series of coils on the tube side of the heat exchanger 40. The high pressure natural gas stream 15 enters the lower end of the housing 30 at inlet 31 and is directed to the inlet manifold 43 located at the upper end of the heat exchanger 40 to the first series of coils. The natural gas stream 15 flows through the first series of coils, exits into the exit manifold 44 located at the lower end of the heat exchanger 40, and is directed to the pressure control system 60 through exit 32 of the housing. After the natural gas stream 15 flows through the pressure control system 60, the stream is directed into the separation chamber 50 located in the lower end of the housing 30 through inlet 33 of the housing 30. The high pressure natural gas stream 15 separates into the low pressure natural gas stream 13 and the natural gas condensate 19. The low pressure natural gas stream 13 flows upward through the flow path 45, while liquid condensate 19 accumulates at the bottom of the housing 30.

The natural gas condensate 19 may be directed to the liquid control system 80 through exit 34 of the housing 30. After the liquid condensate 19 flows through the liquid control system 80, the condensate 19 is directed into the housing 30 through inlet 35 and to the second series of coils of the heat exchanger 40 at inlet 46. The inlet 46 to the second series of coils of the heat exchanger 40 is located at the lower end of the heat exchanger 40. The natural gas condensate 19 flows through the second series of coils of the heat exchanger 40 and exits the second series of coils at exit 47 of the heat exchanger 40. The exit 47 is located at an upper end of the heat exchanger 40. The natural gas condensate 19 is then directed through exit 36 of the housing 30.

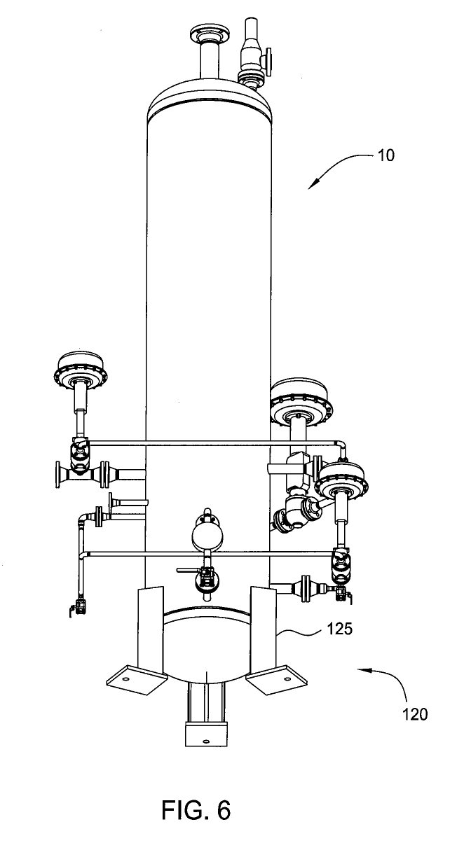

FIG. 6 illustrates a perspective view of a mounting system 120 of the system 10. The mounting system 120 may include a plurality of legs 125 coupled to the lower end of the housing 30. The mounting system 120 is operable to maintain the housing 30 in a stand-alone substantially vertical position.

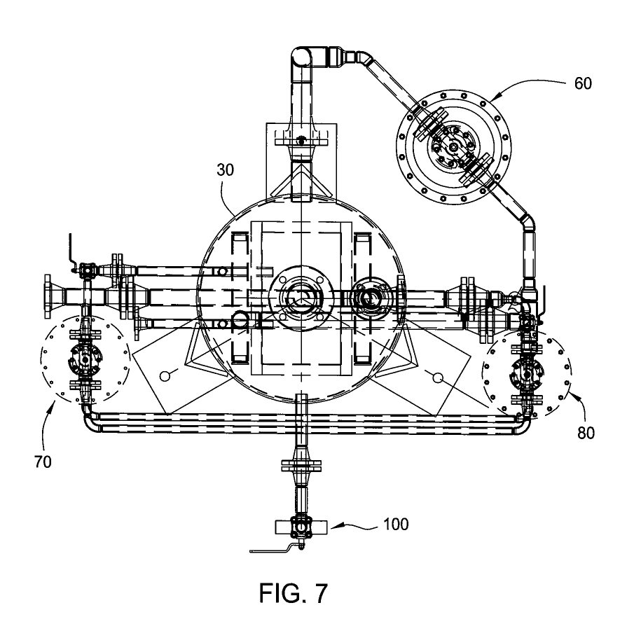

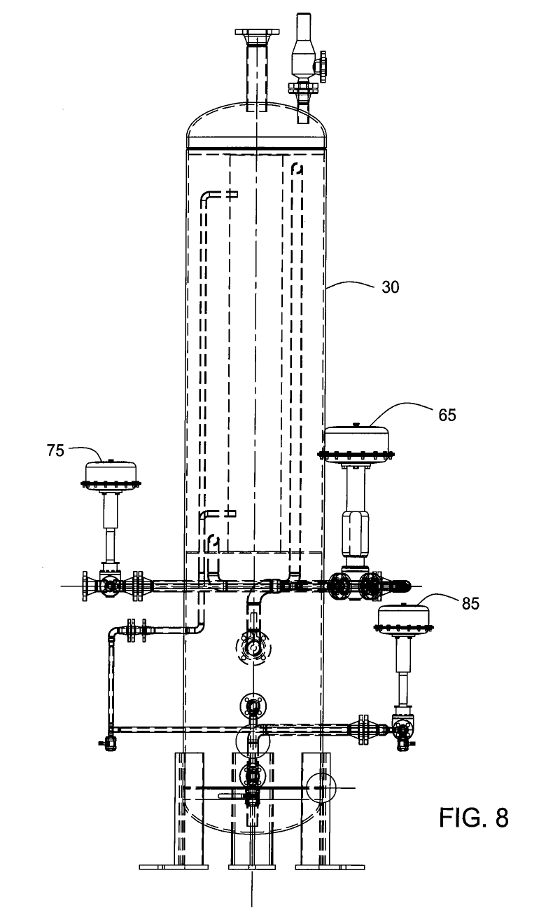

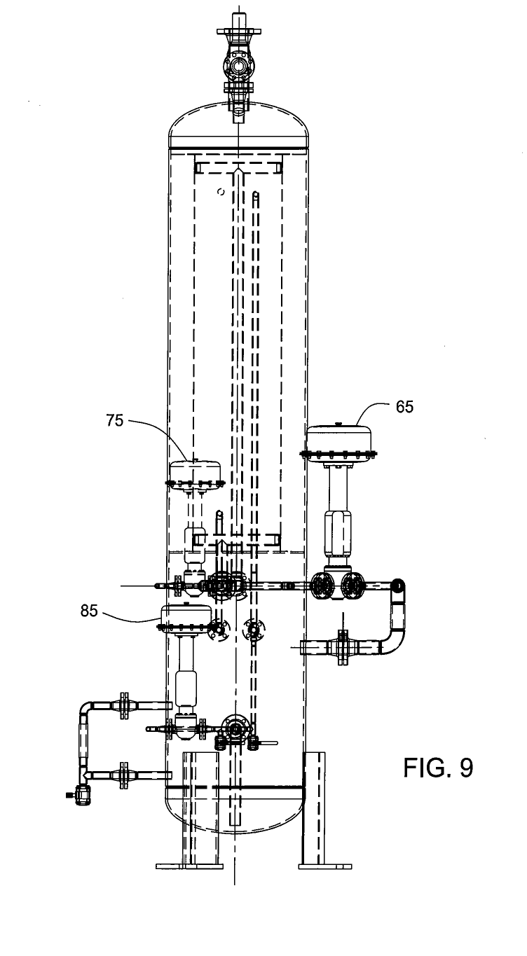

FIG. 7 illustrates a top view of the system 10, and FIGS. 8 and 9 illustrate alternate side views of the system 10. FIGS. 7-9 illustrate the relative spatial locations of the pressure, temperature, liquid, safety, and level control systems surrounding the housing 30. The control systems may be coupled together using various piping structures, including tubing sizes, flange connections, valves, and/or other components necessary to integrate the control systems into the system 10 and to accommodate various applications and environments.

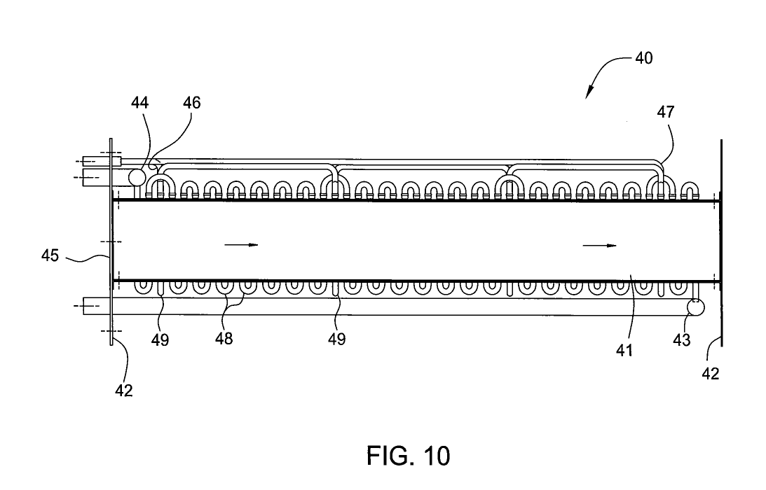

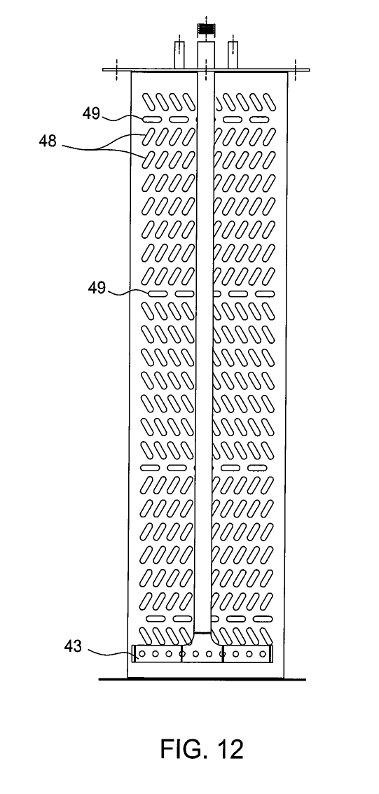

FIG. 10 illustrates a side view of the heat exchanger 40. FIG. 10 illustrates the flow of a fluid through the flow path 45 across the outer surfaces of a first coil fed by manifold 43 and a second coil fed by inlet 46 of the heat exchanger 40. Each of the coils repeatedly traverses the direction of the flow path 45. The first coil may include a plurality of tubes, as shown in FIG. 12, such as ten tubes, disposed adjacent each other across the width of the body 41 of the heat exchanger 40. Each of the tubes may include a plurality of rows 48, such as forty-seven rows, disposed adjacent each other across the longitudinal length of the heat exchanger 40. The second coil may include one or more tubes disposed adjacent each other across the width of the body 41 of the heat exchanger 40. A tube of the second coil may include a plurality of rows 49, such as four rows, equally spaced apart across the longitudinal length of the heat exchanger 40.

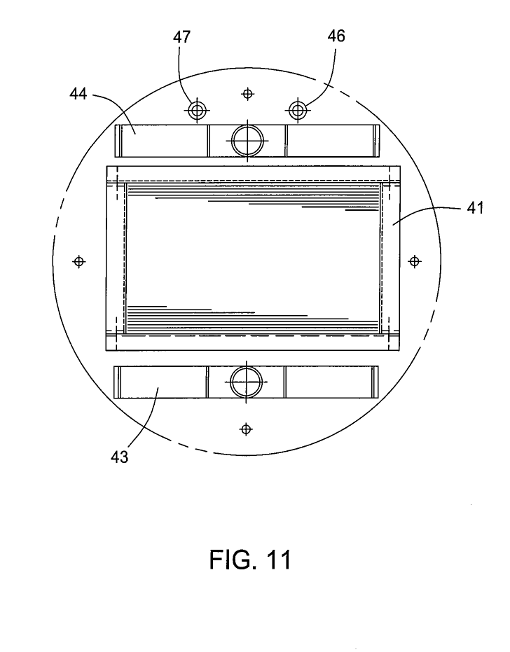

FIG. 11 illustrates a bottom view of the heat exchanger 40. FIG. 11 illustrates the inlet and exit manifolds 43 and 44 located on opposite sides of the body 41 of the heat exchanger 40. Also illustrated are the inlet 46 and the exit 47 located on the same side of the body 41 of the heat exchanger 40 and adjacent each other. FIG. 12 illustrates the plurality of rows 48 of the plurality of tubes of the first coil of the heat exchanger 40. The inlet manifold 43 supplies fluid into each of the tubes of the first coil. Also illustrated is the plurality of rows 49 of the second coil of the heat exchanger 40, each located between a pair of rows 48 of the first coil.

FIGS. 13 and 14 illustrate front and back perspective views, respectively of a heat exchanger 130. The heat exchanger 130 includes a body 133, a first end 131, and a second end 132. The body 131 may include a rectangular shaped frame. The first and second ends 131 and 132 may include circular shaped plates that support the body 133 inside of the housing 30 of the system 10. The first and second ends 131 and 132 may sealingly isolate the heat exchanger 130 within the housing 30 of the system 10 so that fluids introduced into the housing are channeled into a flow path 135 of the heat exchanger 130.

The heat exchanger 130 also includes a first coil 140 and a second coil 150 that are intertwined with each other. The first coil 140 may include a plurality of tubes 144, such as ten tubes, disposed adjacent each other across the width of the body 133 of the heat exchanger 130. Each of the tubes 144 may include a plurality of rows 142, such as forty-seven rows, disposed adjacent each other across the longitudinal length of the heat exchanger 130. Each of the rows 142 alternately traverses the flow path 135, from the front to the back of the heat exchanger 130. The second coil 150 may include one or more tubes 154 that are intertwined with the first coil 140. The tube 154 of the second coil 150 may include a plurality of rows 152, such as four rows, spaced apart across the longitudinal length of the heat exchanger 130. The spacing of the rows 152 of the second coil 150 relative to each other may be uniform or variable. The coil of each row 152 alternately traverses the flow path 135, from the front to the back of the heat exchanger 130 and from one side to the opposite side of the heat exchanger 130 between each tube 144 of the first coil 140. In one embodiment, each row 152 of the second coil 150 is intertwined with each tube 144 of the first coil, such that each row 152 extends across the width of the body 133 of the heat exchanger between each tube 144 of the first coil 140.

In one embodiment, a first row 152 of the second coil 150 is intertwined with a plurality of tubes 144 of the first coil 140, such that the coil of the first row 152 alternately loops between each tube 144 from the front to the back of the heat exchanger 130 and from a first side to a second side of the heat exchanger 130. A second row 152 of the second coil 150 is similarly intertwined with the plurality of tubes 144 of the first coil 140, such that the coil of the second row 152 alternately loops between each tube 144 from the front to the back of the heat exchanger 130 and from the second side to the first side of the heat exchanger 130. The second row 152 of the second coil 150 is located one or more rows 142 of the first coil 140 away from the first row of the second coil 150.

In one embodiment, the second coil 150 may include an inlet manifold coupled to the inlet 137 and an exit manifold coupled to the exit 138 similar to the manifolds 134 and 136 described herein with respect to the first coil 140. The inlet and exit manifolds of the second coil may extend across two or more rows 142 of the first coil 140. The inlet 137 may be directed to the inlet manifold of the second coil 150, which may be in fluid communication with two or more tubes, such that each tube is intertwined with separate and/or adjacent rows 142 of the first coil 140 in the manner described above. Each tube extending from the inlet manifold of the second coil 150 may also include one or more rows that are intertwined with one or more rows 142 of the first coil 140. The one or more rows of the second coil 150 may be uniformly or variably spaced apart. Each tube of the second coil 150 may then terminate in the exit manifold that is in fluid communication with the exit 138.

As shown in FIG. 14, the first coil 140 has an inlet manifold 134 that supplies fluid to each of the tubes 144 of the first coil 140 adjacent the first end 131 on the backside of the heat exchanger 130. The fluid supplied to the first coil 140 flows through the tubes 144 and each row 142 of the tubes 144 from the first end 131 to the second end 132 of the heat exchanger 130. The fluid then exits each tube 144 of the first coil 140 through an exit manifold 136 located near the second end 132 on the front side of the heat exchanger 40. The second coil 150 has an inlet 137 that supplies fluid to the tube 154 of the second coil 150 adjacent the second end 132. The fluid supplied to the second coil 150 on the front side of the heat exchanger 130 flows through the tube 154 and each row 152 from the second end 132 to the first end 131 of the heat exchanger 130. The fluid then exits the tube 154 on the front side of the heat exchanger 130 though an exit 138 located near the second end 132 adjacent the inlet 137 and the exit manifold 136.

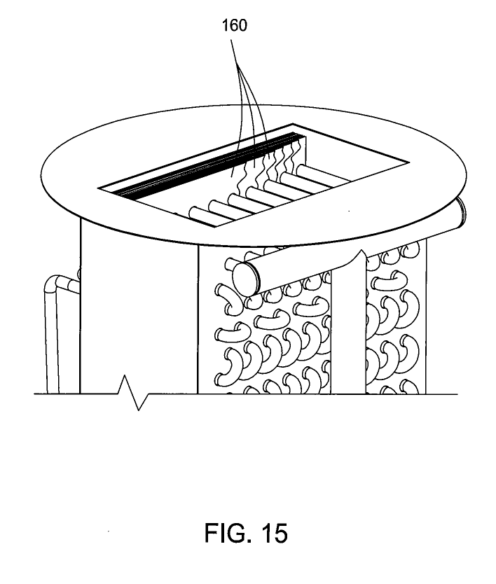

As shown in FIG. 14 and illustrated in FIG. 15, a plurality of fins 160 surround the coils of the heat exchanger 130. In one embodiment, the fins 160 may include plates disposed across the width of the body 133 having openings through which the first and second coils are located. The heat exchanger 130 may include other types of fins to help facilitate heat transfer between the fluids flowing through the first and second coils, as well as the flow path of the heat exchanger.

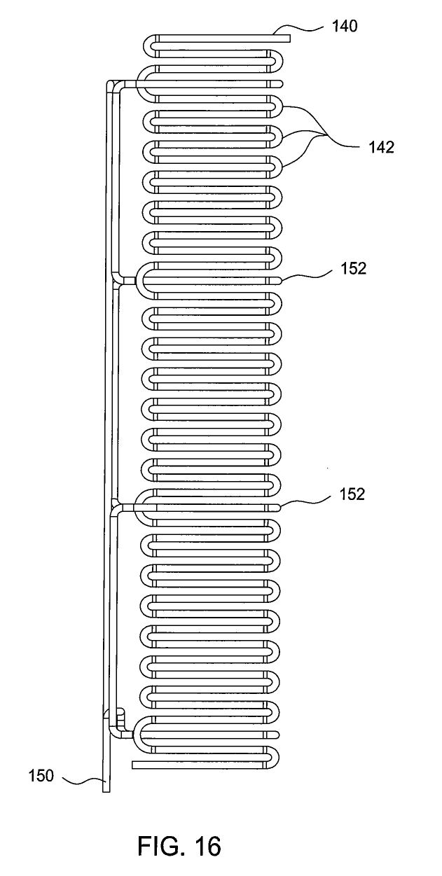

As shown in FIG. 16, a row 152 of the tube 154 of the second coil 150 is disposed between rows 142 of the first coil 140 and is intertwined with each tube 144 of the first coil 140, as shown in FIG. 13. Each of the rows 152 may be equally spaced apart from each other. Each of the rows 152 may be disposed between rows 142 at different distances and locations from each other and/or from an end of the heat exchanger 130.

The embodiments of the system 10 described herein provide several benefits. The BTU per standard cubic foot content of the fuel gas will be lowered due to removal of heavy hydrocarbons from the fuel gas, which provides engine maintenance benefits and dew point control. Since the temperature of the separator is controlled, the fuel gas quality is very consistent even if the inlet pressure, temperature, and/or composition of the fuel gas fluctuates, which improves the reliability of large compressor engines or other types of natural gas engines. Also, the heavy hydrocarbons that are presently being used as fuel gas can be returned to a compressor station, which will increase the BTU value of the compressed gas and increase the total BTU's available for sale. Heating the liquid hydrocarbon condensate also provides improved process efficiency by recovering the refrigeration and is necessary for the stabilization of the liquid condensate, which may reduce horsepower requirements for recompression and/or lower/eliminate the need for additional mechanical refrigeration, thereby providing cost savings.

A method of treating a fluid is provided. The method may include flowing a hot stream of the fluid through a tube side of a first coil, while flowing a cold stream of the fluid on a finned side of the first coil counter-current to the hot stream. A second cold stream of the fluid is flowing on a tube side of a second coil, while flowing the cold stream of the fluid on a finned side of the second coil concurrent to the second cold stream. The second cold stream in the second coil flows counter-current to the hot stream in the first coil. Heat may be transferred from the hot stream to each of the cold streams, and heat may be transferred between the cold streams. Excess heat that is transferred from the hot stream in the first coil to the cold stream on the finned side may be transferred from cold stream on the finned side to the second cold stream in the second coil, thereby allowing the cold stream on the finned side to act as a second hot stream when exchanging heat with the second cold stream in the second coil.

The system 10 may include a refrigeration system disposed adjacent the housing 30 to help control the temperature of the fluid streams flowing in the system 10. The refrigeration system may be operable to reduce the temperature of the natural gas stream flowing through the heat exchanger 40. The refrigeration system may be used instead of or in addition to the pressure control system 60. In some cases it is beneficial to use a refrigeration system rather than a Joule-Thompson expansion for the refrigeration to eliminate the need to recompress the conditioned gas stream after the expansion.

The refrigeration system may include a mechanical refrigeration system and/or an adsorption refrigeration system. In adsorption refrigeration the exhaust heat from an engine could provide adsorption refrigeration using a lithium bromide or aqua ammonia cycle.

The refrigeration system may include a supply/return source and a refrigerant coil interlaced with the heat exchanger 40 for providing a refrigerant stream through the system 10. The refrigeration system may also include one or more devices, such as valves, pumps, compressors, and tubing sections to facilitate the supply and return of a refrigerant fluid to the heat exchanger 40 of the system 10. The refrigerant coil may include inlet and exit manifolds and one or more tubes, each tube having one or more rows, similar to and located in a similar manner as the first coil 140 in the heat exchanger 130, as shown and described with respect to FIGS. 13 and 14. The refrigerant coil may be intertwined with the first coil 140. In one embodiment, the refrigerant coil may be intertwined with the first coil 140, such that the fluids flowing through the respective coils are concurrent or countercurrent to each other. In one embodiment, the second coil 150, as shown and described with respect to FIGS. 13, 14, and 16, may also be intertwined with both the refrigerant coil and the first coil 140 in a similar manner as described above with respect to the first coil 140.

In one embodiment, a refrigerant fluid may be supplied to the refrigerant coil at a low temperature from the supply/return source of the refrigeration system, directed through the heat exchanger, and returned to the supply/return source at a higher temperature. Heat may be transferred to and from the refrigerant fluid using the other streams flowing through the heat exchanger. Heat may be transferred to the refrigerant fluid from the natural gas stream flowing through a first coil on the tube side of the heat exchanger and from the natural gas stream flowing over the refrigerant coil and the first coil on the fin side of the heat exchanger. An amount of heat may be transferred from the natural gas stream flowing through the first coil to the natural gas stream flowing over the first coil and the refrigerant coil, and the amount of heat may be transferred from the natural gas stream flowing over the first coil and the refrigerant coil to the refrigerant fluid flowing through the refrigerant coil. The amount of heat may also be transferred to a liquid component of the natural gas stream that is flowing through a third coil of the heat exchanger from the natural gas stream that is flowing over the first coil, the refrigerant coil, and the third coil on the fin side of the heat exchanger. Thus, the natural gas stream flowing over the first coil, the refrigerant coil, and the third coil on the fin side of the heat exchanger may function as both a cooling and heating fluid stream in the heat exchanger.

The streams in the heat exchanger may recover refrigeration from both the fluid stream flowing over the coils on the fin side of the heat exchanger and from the liquid stream flowing through a coil on the tube side of the heat exchanger. This refrigeration may help reduce the size of the refrigeration system to provide significant cost savings.

A method of treating a fluid is provided. The method includes flowing a stream of a fluid through a first coil of a heat exchanger, flowing a refrigerant stream through a second coil of a heat exchanger, separating a liquid component from the stream of fluid, flowing the liquid component through a third coil of the heat exchanger, and flowing the stream of the fluid over the first coil, the second coil, and the third coil, thereby cooling the stream of the fluid flowing through the first coil and heating the refrigerant stream flowing through the second coil and heating the liquid component flowing through the third coil. The method may include flowing the stream of the fluid over fins surrounding the first, second, and third coil. The method may include flowing the stream of the fluid through the first coil countercurrent to the flow of the refrigerant stream and the liquid component flowing through the second and third coil, respectively. The method may include flowing the stream of the fluid over the first, second, and third coil concurrent to the flow of the refrigerant stream and the liquid component flowing through the second and third coil, respectively. The method may include transferring an amount of heat from the stream of the fluid flowing through the first coil to the stream of the fluid flowing over the first, second, and third coil, and transferring the amount of heat from the stream of the fluid flowing over the first, second, and third coil to the refrigerant stream and the liquid component flowing through the second and third coil, respectively.

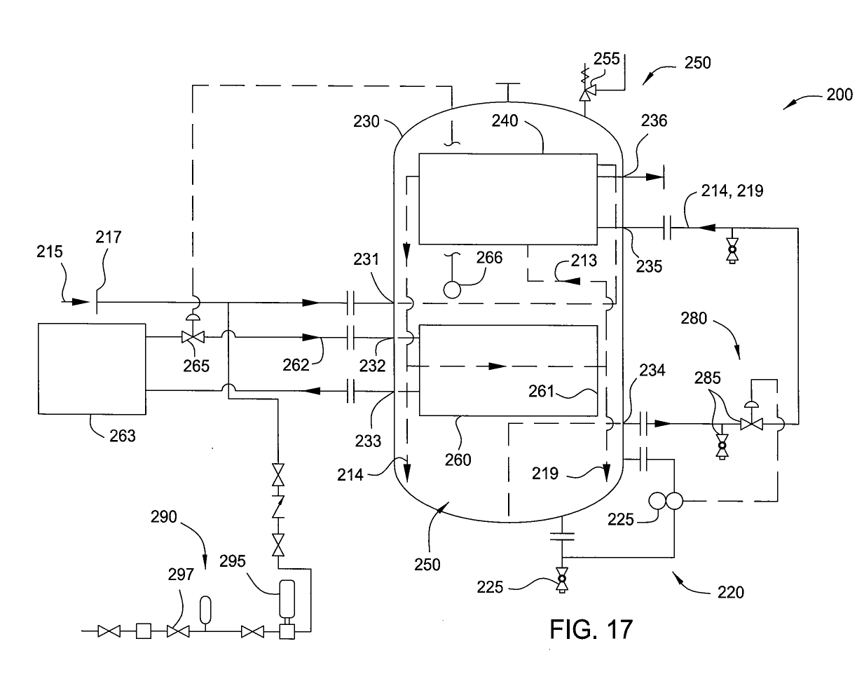

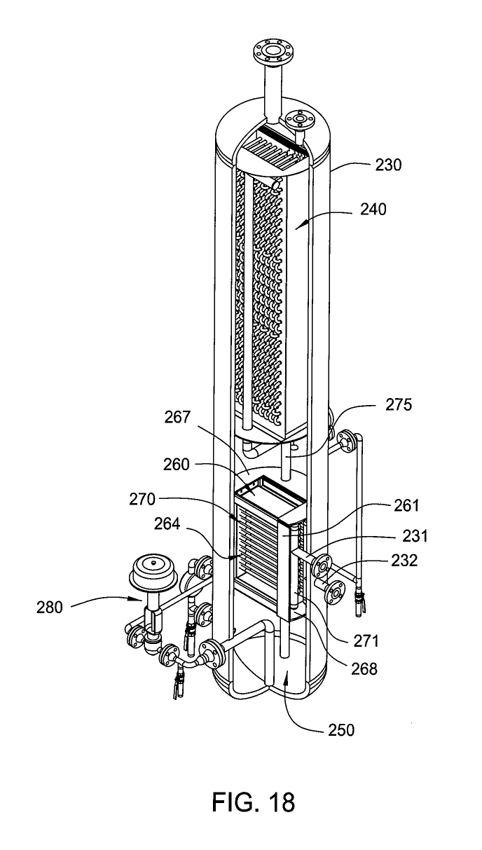

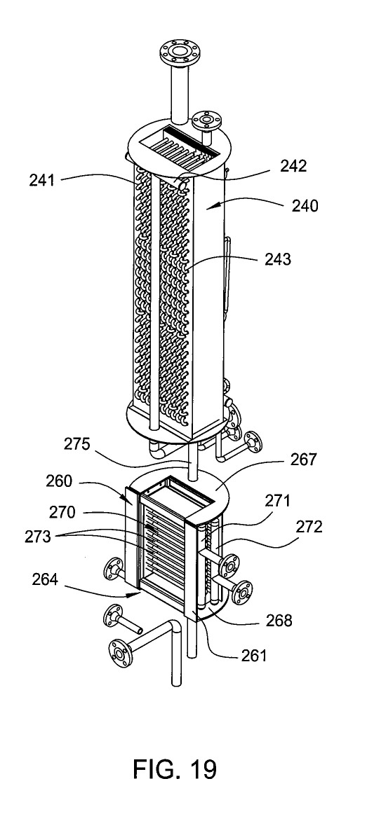

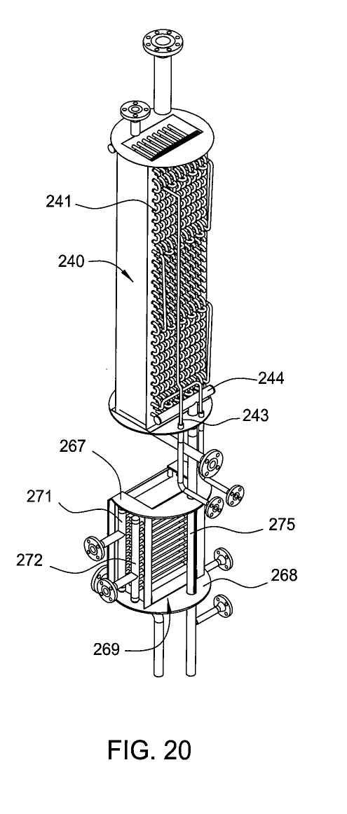

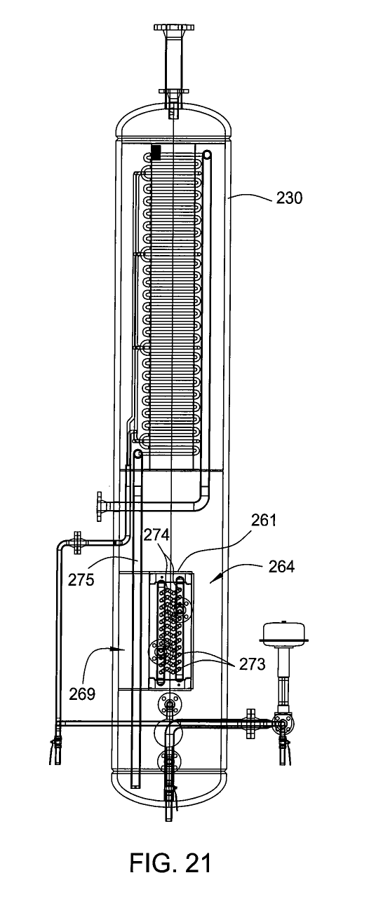

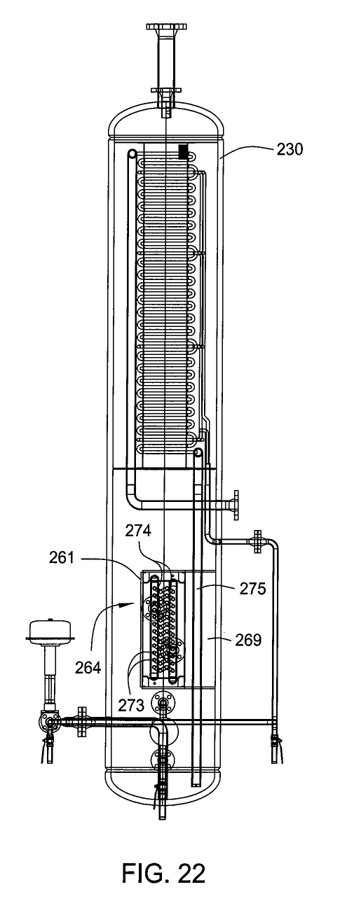

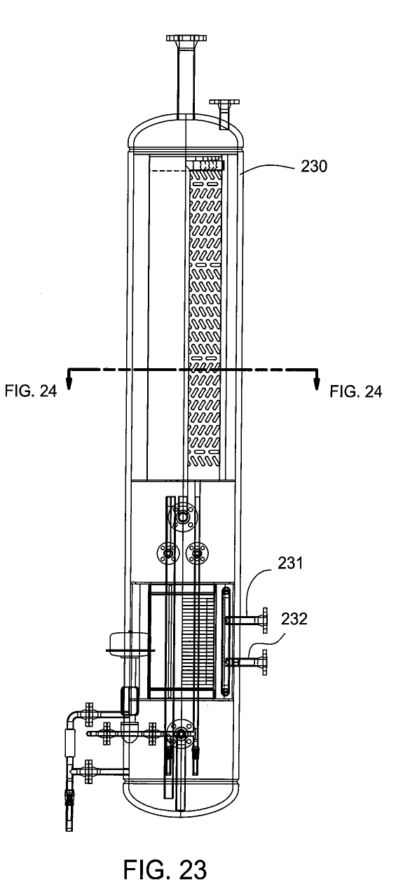

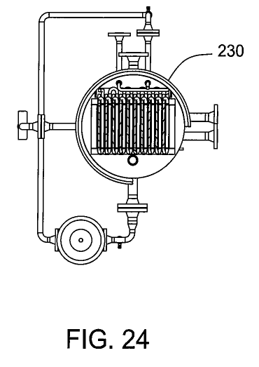

FIG. 17 illustrates a process and instrumentation diagram of a system 200. FIGS. 18, 19, and 20 illustrate isometric views of the system 200. FIGS. 21-24 illustrate sectional views of the system 200. Referring to FIGS. 17-24, the system 200 may include a housing 230, a heat exchanger 240, a refrigeration control system 260, and a liquid control system 280. A fluid stream 215 enters an inlet 231 of the housing 230. The housing 230 may include substantially the same housing as the housing 30 described above. The stream 215 may be injected into the housing 230 using an injection quill 217. The stream 215 is directed to a first series of coils 241 via an inlet manifold 242 as it enters a tube side of the heat exchanger 240. The heat exchanger 240 may include substantially the same heat exchanger as the heat exchanger 40 and/or 130, the embodiments of which may be utilized with the system 200 and which will not be repeated herein for brevity. The stream 215 is cooled as it passes through the heat exchanger 240. The stream 215 may be cooled as it flows through the first series of coils by a fluid stream 213 that is directed across the fin side of the first series of coils of the heat exchanger 240. The stream 215 may also be cooled as it flows through the first series of coils by a stream 214, 219 (further described below) flowing through a second series of coils 243 of the heat exchanger 240. In one embodiment, portions of the flow of the fluids in the first and second series of coils may be directed concurrent, countercurrent, and/or perpendicular to each other. In one embodiment, the fluid flowing across the fin side of the heat exchanger 240 may be directed substantially perpendicular and/or parallel to the flow of fluids in the first and/or second series of coils of the heat exchanger 240.

The stream 215 exits the first series of coils via an outlet manifold 244 where it is then directed to the refrigeration control system 260 disposed within the housing 230 adjacent the heat exchanger 240. The refrigeration control system 260 may include a heat exchange system, such as the heat exchanger 240, a fin and tube type heat exchanger, a plate fin and tube type heat exchanger, or a brazed aluminum type heat exchanger. The refrigeration control system 260 may include a housing 261 and a first coil 270 for flowing a refrigerant stream 262 through the refrigeration control system 260 to cool the stream 215 as it is directed across the first coil, such as across a fin side of the first coil. The refrigerant stream 262 may be provided from a source 263 external to the housing 230 and circulated through the first coil 270 of the refrigeration control system 260 via an inlet 232 and exit 233 of the housing 230. In one embodiment, the flow of the stream 215 may be concurrent and/or countercurrent to the flow of the refrigerant stream 262.

The pressure and temperature changes experienced by the stream 215 as is flows through the heat exchange 240 and refrigeration control system 260 induce the stream 215 to undergo certain phase changes. The pressure and temperature changes may convert the stream 215 into a two-phase stream having a gas component and a liquid component. In one embodiment, the stream 215 may drop below the hydrocarbon dew point of some of the components of the stream 215, thereby forming a liquid condensate and a gas vapor. In one embodiment, a first portion 214 of the stream 215, such as a liquid component of the stream 215, may be separated from the stream 215 prior to entering or when passing through the refrigeration control system 260. The first portion 214 may be collected within the housing 230, such as within a chamber or a bottom end of the housing 230, and directed to a liquid control system 280. In one embodiment, a second portion 219 of the stream 215, such as a liquid component of the stream 215, may be separated from the stream 215 when passing through or upon exiting from the refrigeration control system 260. The second portion 219 may be collected within the housing 230, such as within a chamber or a bottom end of the housing 230, and directed to the liquid control system 280. In one embodiment, the first and second portions of the stream may include natural gas condensate. Separating and removing a liquid component from a stream prior to introducing the stream into the refrigeration control system 260 may allow for less refrigeration required to cool the stream because the removed liquid component does not need to be cooled. In addition, removal of the liquid component prior to refrigeration may prevent some operating hazards, such as freezing problems.

The stream 215 is directed through the refrigeration control system 260 and exits as a conditioned stream 213. The conditioned stream 213 may then be further conditioned as it is directed across the fin side of the heat exchanger 240 and is heated, for example to ambient temperature. The stream 213 is directed across the fin side of heat exchanger 240 and is heated by the stream 215 that is flowing through the first series of coils. The stream 213 directed across the fin side of heat exchanger 240 may also be cooled by the first 214 and/or second 219 portions of the stream 215 that is flowing through a second series of coils of the heat exchanger 240. Therefore, the stream 213 flowing across the fin side of the heat exchanger 240 may act as both a cold stream and a hot stream depending on its heat transfer with the fluids flowing through the first and second series of coils of the heat exchanger 240. The conditioned stream 213 is directed to an exit 237 of the housing 230 and may be used as a fuel gas for example. In one embodiment, the pressure within the housing 230 may be used to direct the stream 213 across the heat exchanger 240 and out of the housing 230.

The first 214 and/or second 219 portions of the stream 215 may be combined and collected within a chamber 250, such as the bottom of the housing 230, and directed through an exit 234 of the housing 230 to the liquid control system 280 located adjacent the housing 230. The portions 214, 219 of the stream 215 are then re-directed to an inlet 235 of the housing 230 into the second series of coils and enter the tube side of the heat exchanger 240 via one or more devices 285, such as a siphon, pump, and/or a valve, of the liquid control system 280. The portions 214, 219 of the stream 215 may be used to provide additional refrigeration for efficiency and flexibility of the system 200. The portions 214, 219 of the stream 215 may be heated to about ambient temperature and exit the tube side of the heat exchanger 240 to an exit 236 of the housing 230. The portions 214, 219 of the stream 215 are directed through the second series of coils of the heat exchanger 240 and are heated by the stream 215 flowing through first series of coils of the exchanger 240. The portions 214, 219 of the stream 215 are also heated by the stream 213 flowing across the fin side of heat exchanger 240. The heated portions 214, 219 of the stream 215 may then be used for other applications. In one embodiment, the pressure within the housing 230 may be used to direct the portions 214, 219 through the liquid control system 280, the heat exchanger 240, and out of the housing 230.

The refrigeration control system 260 may be in fluid communication with the stream 215, the housing 230, the heat exchanger 240, and/or the liquid control system 280 to help maintain and control the temperature of the fluids in the system 200. The refrigeration control system 260 may include one or more devices 265, such as a temperature control valve. In one embodiment, the refrigeration control system 260 may include one or more sensors 266 adapted to monitor the temperature of the streams as they are directed through the system 200. In one embodiment, the refrigeration control system 260 may include a monitoring system operable to heat and/or cool the streams as they are directed through the system 200 upon sensing a specified temperature and/or temperature range by increasing or decreasing the temperature and/or amount of the refrigerant stream 262 flowing through the refrigeration control system 260. In one embodiment, the refrigeration control system 260 is operable to maintain the temperature of the streams in the system 200 within a specified temperature range using the embodiments discussed herein.

The system 200 may include an injection system 290 that is in fluid communication with the inlet stream 215 to dehydrate the fluids in the system 200, such as with the addition of a hydrate suppressant to the fluids to prevent water freeze-up. In one embodiment, a methanol or ethylene glycol injection system 290 may be used. In one embodiment, a molecular sieve dehydration or regenerative glycol injection system 290 may be utilized. In one embodiment, the injection system 290 may include one or more devices 295, such as a pump and flow monitoring devices, and/or one or more devices 297, such as a series of valves or flow control devices.

The system 200 may also include a level control system 220 in fluid communication with the housing 230. The level control system 220 may include one or more devices 225, such as a drain valve, sensors, and a level monitoring device. The level control system 220 may be operable to maintain a specified level of liquids within the housing 230. The system 200 may also include a safety control system 250 located at an upper end of the housing 230. The safety control system 250 may include one or more devices 255, such as a safety control valve and sensors. The safety control system 250 may be operable to prevent the pressure within the housing 230 from rising above a specified pressure.

The system 200 also includes a refrigeration control system 260 disposed within the housing 230 below the heat exchanger 240. The refrigeration control system 260 includes a housing 261, a first end 267, and a second end 268. The housing 261 may include a rectangular shaped frame. The first and second ends 267 and 268 may include partially circular shaped plates that support the housing 261 inside of the housing 230 of the system 200. The first and second ends 267 and 268 may sealingly isolate a portion of the refrigeration control system 260 within the housing 230 of the system 200, thereby forming a chamber 269 with a portion of the housing 230, so that fluids introduced into the chamber 269 of the housing 261 of the refrigeration control system 260 and are directed across the coils, such as a fin side of the coils, of the refrigeration control system 260. The refrigeration control system 260 includes an open side 264 opposite the chamber 269 that allows a fluid directed across the system 260 to exit into the housing 230 of the system 200 and be directed across the heat exchanger 240 and/or to the bottom end of the housing 230.

The refrigeration control system 260 includes a first coil 270 having an inlet manifold 271 and an outlet manifold 272 for supplying a refrigerant fluid to and from the tube side of the system 260. The inlet and outlet manifolds 271 and 272 may be disposed on the same side, such as a right or left side, or opposite sides of the housing 261. The first coil 270 may include one or more tubes 273 disposed adjacent each other across the longitudinal length of the housing 261 of the refrigeration control system 260. Each of the tubes 273 may include one or more rows 274 disposed adjacent each other the across the width of the housing 261. Each of the tubes 273 alternately traverses the housing 261 from a front side to a back side.

The heat exchanger 240 may be in fluid communication with the chamber 269 of the refrigeration control system 260 via an inlet 275. In one embodiment, the inlet 275 includes a tubing or piping section that is coupled to the outlet manifold 244 of the heat exchanger 240 and the first end 267, such as a top end, of the refrigeration system 260. In this embodiment, upon exiting the heat exchanger 240, a stream is introduced into the chamber 269 and directed across the first coil 270, such as the fin side of the first coil 270, of the refrigeration control system 260. In an alternative embodiment the inlet 275 includes a tubing or piping section that is coupled to an outlet manifold of the heat exchanger 240 and extends through the first end 267 (such as a top end) and the second end 268 (such as a bottom end) of the refrigeration system 260, traversing the chamber 269. The portion of the inlet 275 that traverses the chamber 269 may include a plurality of openings, such as ports, slots, or orifices. The portion of the inlet 275 that extends through the second end 268 may stop near the bottom of the housing 230. In this alternative embodiment, upon exiting the heat exchanger 240, a stream is introduced into the chamber 269 via the openings in the inlet 275 and directed across the first coil 270, such as the fin side of the first coil 270, of the refrigeration control system 260. A portion of the stream may also be directed to the bottom of the housing 230 and directed to the liquid control system 280.

A method of treating a fluid is provided. The method includes flowing a stream of a fluid through a first coil of a heat exchanger, flowing a refrigerant stream through a refrigerant coil of a refrigeration control system, separating a liquid component from the stream of fluid flowing through the first coil of the heat exchanger, flowing the liquid component through a second coil of the heat exchanger system, flowing the stream of fluid across the refrigerant coil of the refrigeration control system, and flowing the stream of fluid across the first and second coils of the heat exchanger. The liquid component may be separated from the stream of fluid flowing through the first coil of the heat exchanger before, during, and/or after the stream of fluid flows across the refrigerant coil of the refrigeration control system. The stream of fluid flowing through the first coil of the heat exchanger may be cooled by the liquid component flowing through the second coil and/or the stream of fluid flowing across the first and second coils of the heat exchanger. The liquid component flowing through the second coil of the heat exchanger may be heated by the stream of fluid flowing through the first coil of the heat exchanger and/or the stream of fluid flowing across the first and second coils of the heat exchanger. The stream of fluid flowing across the refrigerant coil may be cooled by the refrigerant stream as it flows through the refrigeration control system. The stream of the fluid flowing across the first and second coils may be heated by the stream of fluid flowing through the first coil of the heat exchanger and may be cooled by the liquid component flowing through the second coil of the heat exchanger. Heat transferred between the stream of fluid flowing through the first coil and the stream of fluid flowing across the first and second coils, may also be transferred between the stream of fluid flowing across the first and second coils and the liquid component flowing through the second coil of the heat exchanger. The method may include flowing the stream of fluid, the liquid component, and/or the refrigerant stream concurrent and/or countercurrent to each other, respectively.

A heat transfer apparatus is provided. The apparatus may include a body, a first series of coils having a plurality of tubes, and a second series of coils having one or more tubes intertwined with the plurality of tubes of the first series of coils. The plurality of tubes may form a plurality of rows and the one or more tubes may form a plurality of rows that are intertwined with the plurality of rows of the first series of coils. The body may surround the first and second series of coils and form a flow path along the longitudinal length of the body across the first and second series of coils. An inlet manifold may be located at an upper end of the body and an exit manifold may be located at a lower end of the body. The apparatus may be one of a fin and tube heat exchanger, a plate fin and tube heat exchanger, and a brazed aluminum heat exchanger.

An apparatus for treating a fluid stream is provided. The apparatus may include a housing, a heat exchanger disposed within the housing and operable to cool the fluid stream, and a control system coupled to the housing and the heat exchanger. The control system is operable to direct a portion of the cooled fluid stream from the housing to the heat exchanger and the heat exchanger is operable to heat portion of the cooled fluid stream. The fluid stream may be introduced into a first coil of the heat exchanger, the portion of the cooled fluid stream may be introduced into a second coil of the heat exchanger, and a refrigerant may be introduced into a third coil of the heat exchanger. The cooled fluid stream may be directed over the first, second, and third coils. The cooled fluid stream directed over the first, second, and third coils may be heated using the fluid stream introduced into the first coil. The heated fluid stream directed over the first, second, and third coils may transfer heat to the portion of the cooled fluid stream introduced into the second coil. The heated fluid stream directed over the first, second, and third coils may transfer heat to the refrigerant introduced into the third coil. The apparatus may also include a refrigeration system coupled to the heat exchanger for supplying a refrigerant to the heat exchanger. The refrigeration system may be a mechanical refrigeration system disposed adjacent the housing. The refrigeration system may be an adsorption refrigeration system disposed adjacent the housing.

A method of treating a fluid is provided. The method may include the steps of flowing the fluid through a first coil of a heat exchanger, flowing a refrigerant stream through a refrigeration coil of a refrigeration system, flowing the fluid across the refrigeration coil, thereby separating the fluid into a gas component and a liquid component, flowing the liquid component through a second coil of the heat exchanger, and flowing the gas component over the first coil and the second coil, thereby cooling the stream of the fluid flowing through the first coil and heating the liquid component flowing through the second coil.

An apparatus for treating a fluid stream is provided. The apparatus may include a housing, a heat exchanger disposed within the housing and operable to condition the fluid stream, a refrigeration system disposed within the housing in fluid communication with the heat exchanger, wherein the refrigeration system is operable to separate the fluid stream into a gas component and a liquid component, and a control system coupled to the housing and the heat exchanger, wherein the control system is operable to direct the liquid component to the heat exchanger.

While the foregoing is directed to embodiments of the invention, other and further embodiments of the invention may be devised without departing from the basic scope thereof, and the scope thereof is determined by the claims that follow.

1. An apparatus for treating a fluid, comprising:
a housing;
a heat exchanger disposed within the housing;
a separation chamber disposed within the housing and operable to separate a liquid component of the fluid; and
a control system in fluid communication with the separation chamber and the heat exchanger, wherein the control system is operable to direct the liquid component from the separation chamber to the heat exchanger.

2. The apparatus of claim 1, wherein the housing comprises a cylindrical vessel.

3. The apparatus of claim 1, wherein the heat exchanger is one of a fin and tube heat exchanger, a plate fin and tube heat exchanger, and a brazed aluminum heat exchanger.

4. The apparatus of claim 1, wherein the heat exchanger comprises a first series of coils and a second series of coils intertwined with the first series of coils.

5. The apparatus of claim 1, wherein the heat exchanger comprises a first series of coils having a plurality of tubes, and a second series of coils having one or more tubes intertwined with the plurality of tubes of the first series of coils.

6. The apparatus of claim 1, wherein the heat exchanger comprises a first series of coils having a plurality of tubes each forming a plurality of rows, and a second series of coils having one or more tubes each forming a plurality of rows that are intertwined with the plurality of rows of the first series of coils.

7. The apparatus of claim 1, wherein the heat exchanger comprises a body having end portions that are sealingly engaged with the housing and forms a flow path along the longitudinal length of the body.

8. The apparatus of claim 1, wherein the heat exchanger comprises an inlet manifold located at an upper end of the heat exchanger and an exit manifold located at a lower end of the heat exchanger.

9. The apparatus of claim 1, wherein the separation chamber is located at a lower end of the housing.

10. The apparatus of claim 1, wherein the control system comprises a liquid control valve operable to control the flow of the liquid component to the heat exchanger.

11. The apparatus of claim 1, further comprising a pressure control system in fluid communication with the housing, wherein the pressure control system is operable to control the pressure in the housing.

12. The apparatus of claim 1, further comprising a pressure control system operable to control the pressure in the housing, wherein the pressure control system comprises at least one of a pressure control valve and a restrictive orifice.

13. The apparatus of claim 1, further comprising a temperature control system operable to control the temperature of the fluid, wherein the temperature control system comprises a temperature control valve.

14. A method of treating a fluid, comprising:
flowing a stream of a fluid through a first coil of a heat exchanger;
flowing a refrigerant stream through a second coil of the heat exchanger;
separating a liquid component from the stream of the fluid flowing through the first coil;
flowing the liquid component through a third coil of the heat exchanger; and
flowing the stream of the fluid over the first coil, the second coil, and the third coil, thereby cooling the stream of the fluid flowing through the first coil, heating the refrigerant stream flowing through the second coil, and heating the liquid component flowing through the third coil.

15. The method of claim 14, further comprising flowing the stream of the fluid over fins surrounding the first, second and third coils.

16. The method of claim 14, further comprising flowing the stream of the fluid through the first coil countercurrent to the flow of the refrigerant stream and the liquid component flowing through the second and third coils, respectively.

17. The method of claim 14, further comprising flowing the stream of the fluid over the first, second, and third coils concurrent to the flow of the refrigerant stream and the liquid component flowing through the second and third coils, respectively.

18. The method of claim 14, further comprising transferring an amount of heat from the stream of the fluid flowing through the first coil to the stream of the fluid flowing over the first, second, and third coils, and transferring the amount of heat from the stream of the fluid flowing over the first, second, and third coils to the refrigerant stream and the liquid component flowing through the second and third coils, respectively.

19. A method of heating and cooling a fluid in a heat exchanger, comprising:
flowing a first stream of a fluid through a first series of coils of the heat exchanger;
flowing a second stream of the fluid through a second series of coils of the heat exchanger; and
flowing a third stream of the fluid over the first and second series of coils, wherein the third stream cools the first stream and heats the second stream.

20. The method of claim 19, further comprising separating a liquid component of the first stream to form the second stream of the fluid.

21. The method of claim 19, further comprising lowering the pressure of the first stream of the fluid to form the third stream of the fluid.

22. The method of claim 19, further comprising transferring an amount of heat from the first steam of fluid to the third stream of fluid, and transferring the amount of heat from the third stream of fluid to the second stream of fluid.

23. The method of claim 19, further comprising heating the third stream of fluid using the first steam of fluid, and heating the second steam of fluid using the third stream of fluid that was heated by the first stream.

24. The method of claim 19, wherein the first stream and the second stream flow countercurrent.

25. The method of claim 19, wherein the second stream and the first stream flow concurrent.

26. A method of treating a fluid, comprising:
flowing a stream of a fluid through a first coil of a heat exchanger;
separating a liquid component from the stream of fluid;
flowing the liquid component through a second coil of the heat exchanger; and
flowing the stream of the fluid leaving the first coil over the first coil and the second coil, thereby cooling the stream of fluid flowing through the first coil and heating the liquid component flowing through the second coil.

27. The method of claim 26, further comprising flowing the stream of the fluid leaving the first coil over fins surrounding the first and second coil.

28. The method of claim 26, further comprising flowing the stream of fluid through the first coil countercurrent to the flow of the liquid component flowing through the second coil.

29. The method of claim 26, further comprising flowing the stream of fluid over the first and second coils concurrent to the flow of the liquid component flowing through the second coil.

30. The method of claim 26, further comprising transferring an amount of heat from the stream of the fluid flowing through the first coil to the stream of the fluid flowing over the first and second coil, and transferring the amount of heat from the stream of the fluid flowing over the first and second coil to the liquid component flowing through the second coil.

31. A method of reducing a heating value of a natural gas stream comprising:
flowing the natural gas stream through a first coil of a heat exchanger;
cooling the natural gas stream, thereby separating a liquid portion of the natural gas stream having a greater heat value than the rest of the cooled natural gas stream;
flowing the liquid portion through a second coil of the heat exchanger;
flowing the cooled natural gas stream over the first and second coils;
heating the cooled natural gas stream flowing over the first and second coils using the natural gas stream flowing through the first coil; and
heating the liquid portion flowing through the second coil using the heated natural gas stream flowing over the first and second coils.

32. A method of controlling the hydrocarbon dew point of a natural gas stream comprising:
flowing the natural gas stream through a first coil of a heat exchanger;
separating a component of the natural gas stream having a dew point greater than the rest of the natural gas stream;
flowing the component through a second coil of the heat exchanger;
flowing the cooled natural gas stream over the first and second coils;
heating the cooled natural gas stream flowing over the first and second coils using the natural gas stream flowing through the first coil; and
heating the component flowing through the second coil using the heated natural gas stream flowing over the first and second coils.

33. An apparatus for treating a fluid stream comprising:
a housing;
a heat exchanger disposed within the housing and operable to condition the fluid stream;
a refrigeration system disposed within the housing and in fluid communication with the heat exchanger, wherein the refrigeration system is operable to separate the fluid stream into a gas component and a liquid component; and
a control system coupled to the housing and the heat exchanger such that the control system is operable to direct the liquid component to the heat exchanger.
